(19) United States
(12) Patent Application Publication
(10) Pub. No.: US 2021/0402880 A1
(43) Pub. Date: Dec. 30, 2021

(54) VEHICLE WIRELESS CHARGER AND WIRELESS CHARGING METHOD USING SAME

(71) Applicant: POWER CAST CO.,LTD., Anyang-si, Gyeonggi-do (KR)

(72) Inventor: Hyun Suk HAN, Incheon (KR)

(73) Assignee: POWER CAST CO.,LTD., Anyang-si, Gyeonggi-do (KR)

(21) Appl. No.: 17/288,777

(22) PCT Filed: Mar. 26, 2019
(86) PCT No.: PCT/KR2019/003469

§ 371 Date: Apr. 26, 2021

(30) Foreign Application Priority Data
Nov. 14, 2018 (KR) 10-2018-0139640

(51) Int. Cl. B60L 1/00; H02J 50/10; H02J 7/00

(52) U.S. Cl. CPC B60L 1/006; H02J 50/10; H02J 2310/48; H02J 7/0044; H02J 2310/22; H02J 7/007182

(57) ABSTRACT

A vehicle wireless charge is provided. A vehicle wireless charger according to an embodiment of the present invention is supplied with external power from a vehicle power source and wirelessly charges a mobile device held thereby, the vehicle wireless charger comprising: a voltage measurement module for monitoring a voltage value of the external power; an auxiliary power storage module for storing auxiliary power by using the external power; a fixing member control module for controlling a fixing member which is provided to fix the mobile device and operates by using the external power or the auxiliary power; and a wireless charging module for wirelessly charging the mobile device, wherein the fixing member control module: fixedly fastens or unfixes the mobile device when the external power is provided; and unfixes the mobile device when the auxiliary power is provided.

### TECHNICAL FIELD

The present invention relates to a wireless charger for a vehicle and a wireless charging method using the same, and more particularly, to a wireless charger that is mounted on a vehicle and automatically fixes a mobile device for wireless charging, and a wireless charging method using the same.

### BACKGROUND ART

In general, a vehicle wireless charger is formed to fix and mount the mobile device so as to charge the battery of the mobile device while driving, as well as to facilitate a call while driving while holding the steering wheel by hand.

In particular, such a vehicle wireless charger uses a fixing member to fix and mount a mobile device, and the fixing member receives external power and operates to automatically fix the mobile device when the mobile device is mounted on the vehicle wireless charger. When a user attempts to separate the mobile device from the wireless charger, the fixing member operates to automatically release the fastening of the mobile device.

However, when the user attempts to separate the mobile device from the wireless charger while the vehicle is turned off, because the vehicle is turned off and external power is not supplied to the vehicle wireless charger, the fixing member cannot be operated so that it is difficult to separate the mobile device.

### DISCLOSURE

### Technical Problem

In order to solve the problems of the related art as described above, an embodiment of the present invention is to provide a vehicle wireless charger capable of releasing a connection between a mobile device and the vehicle wireless charger by operating a fixing member even when external power is not supplied, and a wireless charging method using the same.

### Technical Solution

To achieve the object described above, according to an aspect of the present invention, there is provided a vehicle wireless charger which is supplied with external power from a vehicle power source and wirelessly charges a mobile device to be mounted. The vehicle wireless charger includes a voltage measurement module configured to monitor a voltage value of the external power; an auxiliary power storage module configured to store auxiliary power by using the external power; a fixing member control module configured to control a fixing member which is provided to fix the mobile device and operates by using the external power or the auxiliary power; and a wireless charging module configured to wirelessly charge the mobile device, wherein the fixing member control module fixes or releases the mobile device when the external power is provided and releases the mobile device when the auxiliary power is provided.

The voltage measurement module may include an external voltage measurement not configured to monitor the voltage value of the external power; and an internal voltage measurement unit configured to monitor a voltage value of the auxiliary power supply.

The vehicle wireless charger may further include a mounting state determination module configured to determine whether the mobile device is currently mounted, wherein the auxiliary power storage module stores the auxiliary power by using the external power when the voltage value of the auxiliary power is equal to or less than a preset first voltage reference value and a voltage is supplied from an external power source.

The fixing member control module may control the fixing member by using the external power when the voltage value of the external power measured by the external voltage measurement unit is greater than or equal to a preset second voltage reference value, and may control the fixing member by using the auxiliary power stored in the auxiliary power storage module when the voltage value of the external power is equal to or less than the preset second voltage reference value.

When the mounting state determination module determines that the mobile device is currently mounted, the fixing member control module may control the fixing member to fix or release the mobile device in case the external power is provided, and may release the mobile device by opening the fixing member in case the auxiliary power is provided.

According to another aspect of the present invention, there is provided a wireless charging method using a vehicle wireless charger which is supplied with external power from a vehicle power source and wirelessly charges a mounted mobile device. The wireless charging method includes determining whether the external power is supplied by using a voltage measurement module; determining whether the mobile device is currently mounted by using a mounting state determination module when the external power is supplied; determining whether auxiliary power is stored in an auxiliary power storage module by using the voltage measurement module when it is determined that the mobile device is mounted; and performing wireless charging of the mobile device by using a wireless charging module when it is determined that the auxiliary power is stored, wherein the determining of whether the mobile device is currently mounted includes releasing the fixing member by using the fixing member control module when the mobile device is not mounted, fastening the fixing member by using the fixing member control module when the mobile device is mounted, and releasing by the fixing member control module, the fixing member by using the auxiliary power when the external power is not supplied.

The voltage measurement module may include an external voltage measurement unit and an internal voltage measurement unit, the determining of whether the external power is supplied may include monitoring a voltage value of the external power by using the external voltage measurement unit, and the determining of whether the auxiliary power is stored may include monitoring a voltage value of the auxiliary power by using the internal voltage measurement unit.

The determining of whether the external power is supplied may include releasing or fastening, by the fixing member control module, the fixing member by using the external power when the external power is supplied.

The determining of whether the auxiliary power is stored may include determining that the auxiliary power is not stored and storing the auxiliary power when a voltage value of the auxiliary power, which is measured by the internal voltage measurement unit, is equal to or less than a preset first voltage reference value.

The determining of whether the external power is supplied may include determining that the external power is supplied when a voltage value of the external power, which is measured by the external voltage measurement unit, is equal to or greater than a preset second voltage reference value.

### Advantageous Effects

According to the vehicle wireless charger and the wireless charging method using the same of the embodiments of the present invention, the operation of the fixing member varies depending on the power supply providing power.

In addition, according to the vehicle wireless charger and the wireless charging method using the same of the embodiments of the present invention, even though external power is cut off, the fixing member may perform the releasing operation thereof so that the user may easily remove the mobile device.

### DESCRIPTION DRAWINGS

FIG. 1 is a block diagram illustrating a wireless charging system in which a vehicle wireless charger according to an embodiment of the present invention is connected to a vehicle and a mobile device.

FIG. 2 is a block diagram schematically illustrating the internal configuration of a vehicle wireless charger according to an embodiment of the present invention.

FIG. 3 is a flowchart illustrating a wireless charging method 300 using a vehicle wireless charger according to an embodiment of the present invention.

### BEST MODE

[Mode for Invention]

Hereinafter, various embodiments of the present invention will be described in detail with reference to the accompanying drawings, so that those skilled in the art can easily carry out the present invention. However, the present disclosure is not limited to the embodiments set forth herein and may be modified variously in many different forms. In the drawings, the portions irrelevant to the description will not be shown in order to make the present disclosure clear. The same or similar elements may be marked by the same or similar reference numerals throughout the specification.

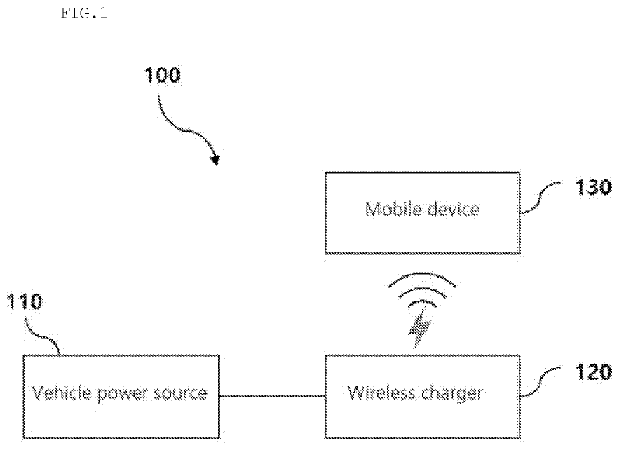

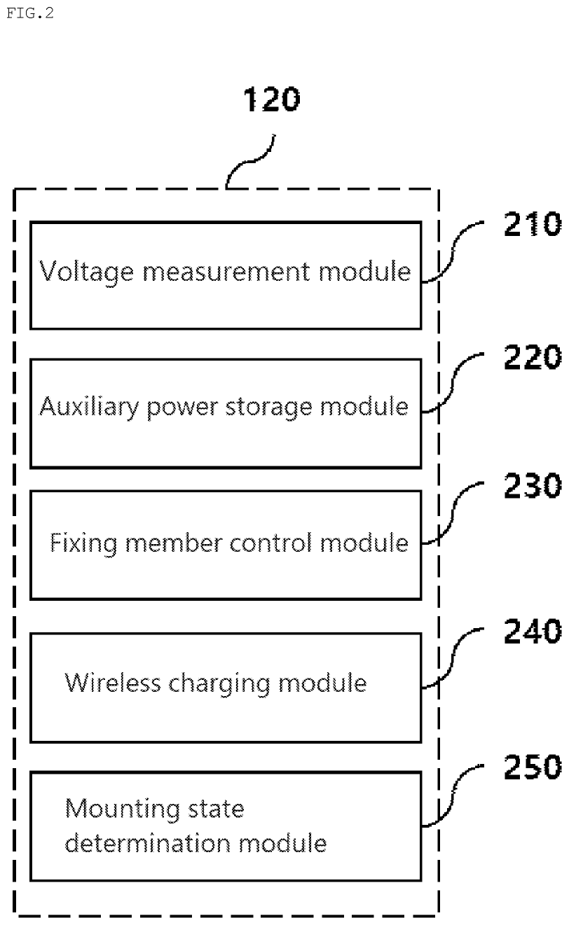

FIG. 1 is a block diagram illustrating a wireless charging system in which a vehicle wireless charger according to an embodiment of the present invention n is connected to a vehicle and a mobile device. FIG. 2 is a block diagram schematically illustrating the internal configuration of a vehicle wireless charger according to an embodiment of the present invention. Hereinafter, a vehicle wireless charger according to an embodiment of the present invention will be described detail with reference to FIGS. 1 and 2.

Referring to FIG. 1, In a wireless charging system 100 include a vehicle wireless charger 120 according to an embodiment of the present invention, the wireless charger 120 receives power from a vehicle power source 110 as external power to perform wireless charging of the mobile device 130.

To this end, the vehicle wireless charger 120 includes a voltage measurement module 210, an auxiliary power storage module 220, a fixing member control module 230, a wireless charging module 240, and a mounting state determination module 250.

The voltage measurement module 210 monitors the voltage value of supplied power. The voltage measurement module 210 includes an external voltage measurement unit that measures the voltage value of external power by using the power supplied from the vehicle power supply 110 as external power, and an internal voltage measurement unit that measures the voltage value of auxiliary power supplied from the auxiliary power storage module 220 to be described later.

The auxiliary power storage module 220 stores auxiliary power by using the external power. The auxiliary power storage module 220 may include, for example, a super capacitor provided in a circuit. The vehicle wireless charger 120 according to an embodiment of the present invention may measure the voltage value of the power stored in the super capacitor by using the internal voltage measurement unit constituting the voltage measurement module 210, and may charge the super capacitor by using the external power when the measured voltage value is equal to or less than a first voltage reference value and the external power is supplied.

In this case, the auxiliary power storage module 220 may be formed to further include a reverse current prevention circuit to prevent reverse current. Preferably, the power storage capacity of the super capacitor included in the auxiliary power storage module 220 may be a capacity capable of releasing the fixing member once.

The fixing member control module 230 is configured to control the fixing member for fixing the mobile device. The fixing member control module 230 controls the fixing member to operate by using the external or auxiliary power.

In this case, the fixing member control module 230 may fasten or release the fixing of the mobile device when the external power is provided, and control the fixing member to release the fixing of the mobile device when auxiliary power is provided.

In particular, when the voltage value of the external power, which is measured using the external voltage measuring unit of the voltage measuring module 210, is equal to or greater than a preset second voltage reference value, the fixing member control module 230 may control the fixing member to operate using the external power. When the voltage value of the external power, which is measured using the external voltage measurement unit, less than the preset second voltage reference value, the fixing member control module 230 may control the fixing member to be released using the auxiliary power.

The wireless charging module 240 is provided for wireless charging of the mobile device 130. The wireless charging module 240 receives the external power and performs wireless charging of the mobile device 130. In this case, when the voltage value of the external power measured by using the external voltage measurement unit is less than the preset second voltage reference value, the wireless charging module 240 stops charging.

In addition, in the wireless charging module 240, the above-described super capacitor may be further included in a wireless charging circuit included in the wireless charging module 240. Thus, according to the present invention, another super capacitor may be further added to the auxiliary power storage module 220, so that it is possible to effectively use the circuit.

The mounting state determination module 250 is provided to determine whether the mobile device 130 is currently mounted on the vehicle wireless charger 120. To this end, the mounting state determination module 250 may use an infrared sensor, a proximity sensor, or a weight sensor, and may generate electromagnetic induction with a wireless charging unit formed in the mobile device 130 in order to determine whether the mobile device 130 is mounted according to whether the electromagnetic induction is generated.

Meanwhile, the fixing member control module 230 may further use the mounting state determination module 250 to control the fixing member. When the mounting state determination module 250 determines that the mobile device 130 is mounted, the fixing member control module 230 may control the fixing member to fasten or release the fixing of the mobile device when the external power is supplied. When the auxiliary power is provided, the fixing member control module 230 may release the fixing member to release the fixing of the mobile device.

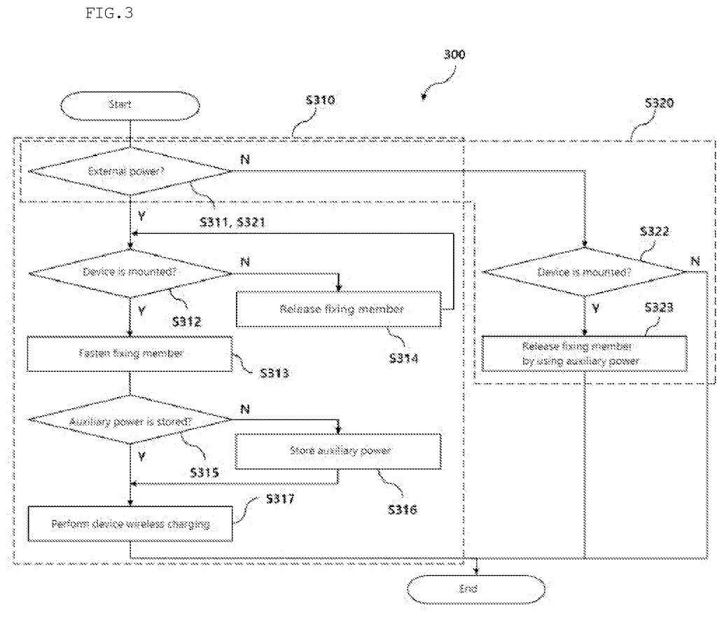

FIG. 3 is a flowchart illustrating a wireless charging method 300 using a vehicle wireless charger according to an embodiment of the present invention. Although the wireless charging method is described by using the vehicle wireless charger 120 described in FIGS. 1 and 2 as an apparatus for performing the wireless charging method of FIG. 3 in the following description, the present invention is not limited thereto.

The wireless charging method 300 using a vehicle wireless charger according to an embodiment of the present invention includes a step S310 of performing wireless charging and a step S320 of ending wireless charging.

According to an embodiment of the present invention, the step S315 of performing wireless charging includes a step S311 of determining whether external power is supplied, a step S312 of determining whether a mobile device is mounted, a step S315 of determining whether auxiliary power is stored, and a step S317 of performing wireless charging of the mobile device.

First, in the step S310 of performing wireless charging according to an embodiment of the present invention, in step S311, it is determined whether the external power is supplied to the vehicle wireless charger by using the voltage measuring module. The voltage measurement module monitors the voltage value of the supplied power. The voltage measurement module measures the voltage value of the external power by using an external voltage measurement unit constituting the voltage measurement module, which is the power supplied form a vehicle power source.

In this case, when the value of the external voltage measured by using the external voltage measurement unit is greater than or equal to the preset second voltage reference value, the vehicle wireless charger may determine that external power is supplied, and may determine that the external power is supplied when the measured value of the external voltage is smaller than the preset second reference voltage value.

In step S312, when it is determined that external power is supplied, the vehicle wireless charger determines whether the mobile device is currently mounted by using the mounting state determination module.

The mounting state determination module is provided to determine whether the mobile device is currently mounted on the vehicle wireless charger. The mounting state determination module may use an infrared sensor, a proximity sensor, or a weight sensor for this purpose, and may determine whether the mobile device is mounted according to the presence or absence of an electromagnetic induction phenomenon by generating electromagnetic induction with a wireless charging unit formed in the mobile device.

In step S313, when it is determined that the mobile device is mounted, the vehicle wireless charger uses the fixing member control module to fasten the fixing member in order to fix the mobile device to the wireless charger. In this case, the fixing member control module may fasten the fixing member by using the external power supplied.

To the contrary, when it is determined that the mobile device is not mounted, the vehicle wireless charger releases the fixing member by using the external power to mount the mobile device in step S314, and then performs step S312 again to fasten the fixing member after the mobile device is mounted.

When the fixing member control module fastens the fixing member by performing step S313, in stet S315, the vehicle wireless charger determines whether the auxiliary power is stored in the auxiliary power storage module.

The vehicle wireless charger uses the internal voltage measurement unit constituting the voltage measurement module to determine whether the auxiliary power is stored in the auxiliary power storage module. The internal voltage measurement unit measures the voltage value of power stored in the super capacitor included in the auxiliary power storage module. In this case, when the voltage value measured by the internal voltage measurement unit is less than or equal to the first voltage reference value, in step S316, the vehicle wireless charger determines that the auxiliary power is not charged in the auxiliary power storage module and stores the auxiliary power in the super capacitor by using the external power.

Finally, after determining that the auxiliary power is stored in the auxiliary power storage module in step S315, or storing the auxiliary power while performing step S316, in step S317, the vehicle wireless charger may perform the wireless charging of the mobile device which is fixedly fastened through the fixing member to the vehicle wireless charger, by using the wireless charging module.

Meanwhile, the step S320 in which wireless charging is terminated according to an embodiment of the present invention includes a step S321 of determining whether the external power is supplied, a step S322 of determining whether a mobile device is mounted, and a step S323 of using the auxiliary power to release the fixing member.

First, in step S310 in which wireless charging is terminated according to an embodiment of the present invention, the vehicle wireless charger uses the voltage measurement module to determine whether the external power is supplied in step S321. The voltage measurement module monitors the voltage value of the supplied power. The voltage measurement module uses the external voltage measurement unit constituting the voltage measurement module to measure the voltage value of the external power which is supplied from the vehicle power source as external power.

In this case, when the value of the external voltage measured by using the external voltage measurement units greater than or equal to the preset second voltage reference value, the vehicle wireless charger may determine that the external power is supplied. When the value of the external voltage measured is less than or equal to the preset second voltage reference value, the vehicle wireless charger may determine that the external power is not supplied.

When it is determined that external power is not supplied, then, in step S322, the vehicle wireless charger determines whether a mobile device is currently mounted by using the mounting state determination module.

The device placement determination module is provided to determine whether the mobile device is currently being mounted on a vehicle wireless charger. To this end, the mounting state determination module may use an infrared sensor, a proximity sensor, or a weight sensor, and may determine whether the mobile device is mounted according to the presence or absence of an electromagnetic induction phenomenon by generating electromagnetic induction with the wireless charging unit formed in the mobile device.

When it is determined that the mobile device is mounted, in step S323, the vehicle wireless charger releases the fixing member by using the fixing member control module so that the user can easily remove the mobile device. In this case, since the vehicle wireless charger does not receive the external power, the vehicle wireless charger may operate the fixing member by using the auxiliary power stored in the auxiliary power storage module in the step S310 of performing wireless charging.

Although the exemplary embodiments of the present invention have been described above, the spirit of the present invention is not limited by the exemplary embodiments presented herein. Those skilled in the art who understand the spirit of the present invention will be able to easily propose other embodiments by adding, changing, or deleting components within the scope of the same idea, but this is also within the scope of the present invention.

1. A vehicle wireless charger which is supplied with external power from a vehicle power source and wirelessly charges a mobile device to be mounted, the vehicle wireless charger comprising:
a voltage measurement module configured to monitor a voltage value of the external power;
an auxiliary power storage module configured to store auxiliary power by using the external power;
a fixing member control module configured to control a fixing member which is provided to fix the mobile device and operates by using the external power or the auxiliary power; and
a wireless charging module configured to wirelessly charge the mobile device,
wherein the fixing member control module fixes or releases the mobile device when the external power is provided and releases the mobile device when the auxiliary power provided.

2. The vehicle wireless charger of claim 1, wherein the voltage measurement module includes an external voltage measurement unit configured to monitor the voltage value of the external power; and
an internal voltage measurement unit configured to monitor a voltage value of the auxiliary power supply.

3. The vehicle wireless charger of claim 2, further comprising:
a mounting state determination module configured to determine whether the mobile device is currently mounted,
wherein the auxiliary power storage module stores uric auxiliary power by using the external power when the voltage value of the auxiliary power is equal to or less than a preset first voltage reference value and a voltage is supplied from an external power source.

4. The vehicle wireless charger of claim 3, wherein the fixing member control module controls the fixing member by using the external power when the voltage value of the external power measured by the external voltage measurement unit is greater than or equal to a preset second voltage reference value, and controls the fixing member by using the auxiliary power stored in the auxiliary power storage module when the voltage value of the external power is equal to or less than the preset second voltage reference value.

5. The vehicle wireless charger of claim 4, wherein, when the mounting state determination module determines that the mobile device is currently mounted, the fixing member control module controls the fixing member to fix or release the mobile device in case the external power is provided, and releases the mobile device by opening the fixing member in case the auxiliary power is provided.

6. A wireless charging method using a vehicle wireless charger which is supplied with external power from a vehicle power source and wirelessly charges a mounted mobile device, the wireless charging method comprising:
determining whether the external power is supplied by using a voltage measurement module;
determining whether the mobile device currently mounted by using a mounting state determination module when the external power is supplied;
determining whether auxiliary power is stored in an auxiliary power storage module by using the voltage measurement module when it is determined that the mobile device is mounted; and
performing wireless charging of the mobile device by using a wireless charging module when it is determined that the auxiliary power is stored,
wherein the determining of whether the mobile device is currently mounted includes releasing the fixing member by using the fixing member control module when the mobile device is not mounted, fastening the fixing member by using the fixing member control module when the mobile device is mounted, and releasing, by the fixing member control module, the fixing member by using the auxiliary power when the external power is not supplied.

7. The wireless charging method of claim 6, wherein the voltage measurement module includes an external voltage measurement unit and an internal voltage measurement unit,
the determining of whether the external power is supplied includes monitoring a voltage value of the external power by using the external voltage measurement unit, and
the determining of whether the auxiliary power is stored includes monitoring a voltage value of the auxiliary power by using the internal voltage measurement unit.

8. The wireless charging method of claim 7, wherein the determining of whether the external power is supplied includes releasing or fastening, by the fixing member control module, the fixing member by using the external power when the external power is supplied.

9. The wireless charging method of claim 8, wherein the determining of whether the auxiliary power is stored includes determining that the auxiliary power is not stored and storing the auxiliary power when a voltage value of the auxiliary power, which is measured by the internal voltage measurement unit, is equal to or less than a preset first voltage reference value.

10. The wireless charging method of claim 9, further comprising:
determining that the external power is supplied when a voltage value of the external power, which is measured by the external voltage measurement unit, is equal to or greater than a preset second voltage reference value.
